(19) United States
(12) Patent Application Publication
(10) Pub. No.: US 2015/0306967 A1
(43) Pub. Date: Oct. 29, 2015

(54) IDENTIFICATION OF AN ELECTRIC VEHICLE ADJACENT TO A POWER REPLENISHMENT STATION

(71) Applicant: Motty COHEN, Kiryat Motzkin (IL)

(72) Inventor: Motty COHEN, Kiryat Motzkin (IL)

(73) Assignee: BETTER PLACE GMBH, Zug (CH)

(21) Appl. No.: 14/238,705

(22) PCT Filed: Aug. 15, 2012
(86) PCT No.: PCT/IL2012/050311

§ 371 Date: May 6, 2015

Related U.S. Application Data
(60) Provisional application No. 61/524,284, filed on Aug. 16, 2011.
(60) Provisional application No. 61/560,120, filed on Nov. 15, 2011.

(51) Int. Cl. B60L 11/18; B60L 3/12

(52) U.S. Cl. CPC B60L 11/1846; B60L 3/12; B60L 11/1822; B60L 11/1825

(57) ABSTRACT

The present invention concerns a technique (method and a system) for use in servicing of electric vehicles at power replenishment service stations. The technique of the invention enables identification of a respective vehicle located at the power replenishment service station by carrying out the following: receiving and processing user request data from at least one power replenishment service station for identifying therein user data indicative of a user requesting power replenishment service, receiving and processing data from control systems of vehicles for identifying certain data including at least specific vehicle data, and processing the user data and the specific vehicle data and identifying the respective vehicle located at the power replenishment service station to thereby enable management of services to be provided to the respective vehicle.

### TECHNOLOGICAL FIELD

This invention relates to servicing electric vehicles at power replenishment stations and particularly to identification of electric vehicles in the vicinity of the power replenishment stations service stations.

### BACKGROUND

A vehicle (e.g., car, truck, plane, boat, motorcycle, autonomous vehicle, robot, forklift truck, etc.) is an integral part of the modern economy. Unfortunately, fossil fuels, like oil which is typically used to power such vehicles, have numerous drawbacks including their dependence on limited sources of fossil fuels, the fact that the sources are often in volatile geographic locations, and also that such fuels produce pollutants and likely contribute to climate change. One way to address these problems is to increase the fuel efficiency of the vehicles.

Recently, gasoline-electric hybrid vehicles have been introduced, which consume substantially less fuel than their traditional internal combustion counterparts, i.e., they have better fuel efficiency. Fully-electric vehicles are also gaining popularity. Batteries play a critical role in the operation of such hybrid and fully-electric vehicles. With a typical electric vehicle battery, the electric vehicle may be able to travel within a distance range of about 160 kilometers before a need to recharge/replace the battery. Then, the spent battery needs to be charged or exchanged to allow the vehicle to travel beyond the single-charge travel range.

### GENERAL DESCRIPTION

Electric vehicles (EV), including partially electric (hybrid) or fully-electric driven vehicles, typically utilize servicing to replenish their battery charging state. Replenishing power of an EV is generally provided by power replenishment stations (i.e. service stations) such as a battery service station including a charging pole and/or a battery exchange system. For providing suitable service to an EV, it is important to determine/identify at least one of the type/model of the battery to be serviced, a serial/identification number corresponding thereto or to identify the type/model/serial number of the vehicle upon which the battery is installed.

Identifying data corresponding to any one or more of the above enumerated identification options or any other data suitable for identification of an EV or a battery installed thereon is commonly and alternatively referred to herein as vehicle-identification or vehicle related data determination.

Vehicle-identification may, for example, be required to allow one or more of the following: billing for battery replenishment services rendered to the identified EV; determining a suitable charging protocol to be used for charging the EV by a charging pole; determining of a charging plan for charging the EV's battery. The latter may require use of data indicative of the state of the battery in the EV, the typical power consumption of the EV, as well as information on the user of the EV and his driving habits.

It is typically necessary to identify the type/model of the battery to be replenished to allow supplementation of the proper charging plane or to allow exchanging the battery with another compatible battery. Specifically, in order to charge an EV's battery at a charging station, it is, in many cases, desired/required to identify the battery and to gain access to specific battery information such as charging history, battery condition and so forth. Utilizing such specific battery information allows provision of cost effective and efficient battery charging. A battery type or identity may be obtained by identifying the battery itself (e.g. its serial number) or by identifying the type or identity of the EV's upon which the battery is installed.

In order to further improve the efficiency of power replenishment services, it may also be desired to obtain information identifying the EV to be serviced at a service station and/or identifying its user. Such data allows maintaining and utilizing usage related information which may be utilized to provide the EV with a better suited power replenishment service/plan. Such usage related information may for example include vehicle usage history, expected/predicted usage, user's profile (e.g. driving style or habits, commonly used roots and timings), power consumption etc.

However, there is currently no efficient way to identify the type/model/serial number of an EV or an EV's battery located in the vicinity of a power replenishment station in general and in particular it is difficult to identify the battery of an EV located near a charging station (e.g. charging pole). Current standardized cables used for charging EVs are not configured for data communication between the charging pole and the EV being serviced. As a result, a communication deficiency/gap arises from the inability of EV's to transmit identifying information to service stations. As such, a need exists for n easy and efficient system and method for identifying an electric vehicle (and/or its battery) at a service station.

Particularly, service stations providing battery charging services are typically implemented as charging poles. Charging poles are typically relatively low-cost systems/utilities (e.g. as compared with battery exchange stations) and are deployed in relatively large quantities and with dense distributions (e.g. with down to a few meters apart from one another) in areas where users tend to park their vehicles for several hours (such as in industrial parks and residential areas). As a result, various vehicle identification techniques, such as vehicle-plate identification/recognition, might be inapplicable for charging poles due to relatively complicated and high-cost identification systems, and also due to their poor performance in irregular environment conditions (vehicles may be positioned with various orientations in the vicinity of a charging pole). Also, the identification technique relies on wireless communication, such as WIFI, between the vehicle and a charging pole, may suffer from ambiguous or redundant identification of the vehicle at multiple charging poles and may also suffer from false identification of vehicles which pass near the charging poles.

The present invention allows bridging this communication gap between a power replenishment station and an EV to be serviced thereby and to overcome the above described drawbacks. According to some aspects of the present invention this gap is bridged by utilizing communication with a user's device (e.g. mobile handset associated with the user of the EV). This may be achieved by utilizing various communication abilities/modules with which various mobile handsets are equipped, such as near field communication (NFC), Radio-frequency identification (RFID), Bluetooth (BT) and wireless-local-area-network (WLAN/WIFI).

For example, the user device can be used to identify the user at a power replenishment service station (service station). The power replenishment station may further transmit this user identification data (user-data) to a central station (control center) to indicate which user currently requests to be serviced by the service station. Such communication between the user device and the service station may be based on wireless communication. In some cases, in which several power replenishment service stations (e.g. charging poles), are located in close proximity to one another, near field communication technologies such as NFC and RFID are preferably used by the service stations for identifying a user, or a user's handset, thus avoiding ambiguous and false identification of the user. For example, service stations may be distant from one another by less than a coverage range of WIFI and BT technologies (e.g. less then a hundred meters). In such cases, the user may approach and identify himself to the service station by utilizing a handheld device equipped with near field communication technology such as NFC and RFID.

It should be noted that communication between the user device and the service station may be based on wireless communication such as those described above in relation to the communication between a user device and the EV. It should also be understood that the user device may be a handheld device such as a mobile handset, phone, or an NFC card, and also a user's device may be integral with the EV's control system in which case the EV itself may be considered as a user's device. In some cases, the user device, in addition to communicating user info to the service station, notifies the in-vehicle control system about initiation of a service plane (e.g. battery charge/exchange) by the station.

In some cases, the user device may also be used to identify the vehicle's user to the control system of the vehicle he is currently using. The vehicle may then communicate this vehicle associated user data to a central station (control center) to indicate its current/contemporary user. A user's handheld device associated with the EV's control system might also be able to consume different services from the vehicle's computer (e.g. Web surfing, etc.). To this end, according to some embodiments of the invention, a communication between the EV and the user's handset may be exploited to identify the user to both the service station and the EV's control system.

As the user is identified at the service station, or before or after the identification process, the EV's control system communicates to the control center certain information including vehicle related data (including data indicative of the vehicle's identity). The control center may then cross reference the data received from various EV's and data received from the service stations and determine an association between the specific service station/charge pole and the specific EV to be serviced/charged thereby. Cross referencing these data for matching between a particular vehicle and a particular power replenishment station/system may possibly be assisted by additional data/information which may be provided/sent from one or more of the vehicles, from one or more of the service stations and/or from another data repository associated with the control center.

For example, additional information/data provided from the vehicle may include one or more of the following: the position of the vehicle as may be received from a GPS system onboard the vehicle, a list of users associated with the vehicle and/or a current vehicle related user data indicating the current user of the EV, as well as other factors associated with the vehicle. In addition, for example additional information/data provided from the service station may include the user-data indicating the user currently requesting service from the service station, the service station location and/or as other factors associated with the user or the service station. Yet additionally, further information/data provided from data repository associated with the control center may for example include a list of EVs that are associated with specific user. A match between the EV and a service station may be determined (e.g. at the control center) by utilizing such additional data and possibly also by utilizing the timing of the data communication events.

Thus, according to the invention, the data obtained at the control center from various electric vehicles (EV's) and from various service stations for determining which vehicle/battery is in the vicinity of which service station, and accordingly determines the type and/or scheme of power replenishment plan to be provided by each station to each vehicle.

According to a broad aspect of the present invention there is provided a service system for use in facilitating servicing of electric vehicles. The service system includes one or more communication modules for connection to a communication network, and a processor utility configured and operable for carrying out the following:
receiving and processing user request data from at least one power replenishment service station and identifying user data therein;
receiving and processing data from control systems of vehicles and identifying certain data including at least specific vehicle data; and
processing the user data and the at least specific vehicle data to identify the respective vehicle located at the power replenishment service station, and generating data indicative thereof thereby enabling management of servicing of the respective vehicle.

According to some embodiments the certain data, which is received from the control systems of vehicles, includes vehicle associated user data indicative of a user using the vehicle. The processor utility may be configured and operable to determine a match between vehicles associated user data obtained from one or more vehicles and user data indicated in one or more user requests (e.g. user request data received from one or more power replenishment stations) and thereby determine a specific vehicle located adjacent to a specific power replenishment station.

Alternatively or additionally, according to some embodiments of the present invention the processing utility is configured and operable for carrying out the following in order to determine a respective vehicle located at the power replenishment service station: (a) identify a list of a plurality of vehicles associated with the user based on the identification of the user requesting service at the power replenishment station; (b) obtain one or more factors associated with at least one of the vehicle and the user and; (c) utilize these one or more factors to determine a match between the respective vehicle and a user requesting service at the power replenishment station thereby determine which respective vehicle of the plurality of vehicles associated with the user is located adjacent to the power replenishment station. In some embodiments at least one of these factors is included in the certain data which is received from the control systems of vehicles. These one or more factors may include for example one or more of the following: a charge event received from the vehicle located adjacent to the power replenishment service station, a vehicle usage history associated with the user, battery service history associated with the user, a location of the vehicle.

Thus, according to some embodiments of the present invention the processing utility is configured and operable for identifying the respective vehicle, which is adjacent to the power replenishment station, by carrying out at least one of the following:
a. matching user data (e.g. received with the user request for service) with vehicle associated user data indicative of a user using the vehicle; and
b. processing data indicative of a list of a plurality of vehicles associated with the user by filtering the data indicative of the list utilizing one or more factors associated with at least one of the vehicle and the user. The filtering includes at least one of the following:
   utilizing at least one of a vehicle and battery usage history associated with the user and determining that a vehicle frequently used by the user is said respective vehicle;
   matching a charge event data received from a certain vehicle in the list with a charge event received from the power replenishment station;
   matching a location of a certain vehicle in the list with a location of said power replenishment station from which the user request had been received.

According to some embodiments, the system of the invention is configured and operable as a control center connectable to one or more power replenishment service stations via the communication network. The one or more communication modules of the system include: an electric vehicle (EV) communication module configured and operable for communication with control systems of multiple EVs and receiving therefrom at least the vehicle data and a station-communication module configured and operable for communication with the one or more power replenishment stations for receiving therefrom the user request data including at least the user data. In some cases the EV communication module is configured to communicate with the control system of the vehicle by mediation of a power replenishment station in the vicinity thereof the vehicle is located.

According to some embodiments, the system of the invention includes a vehicle locator module. The vehicle locator module is adapted to utilize data received from the control system of the vehicle and data received from the one or more power replenishment stations to determine a certain power replenishment station in the vicinity of which the vehicle is located.

According to some embodiments, the system of the invention includes a battery information module. The battery information module is adapted to utilize the vehicle data and determine corresponding operative data for power replenishment of the vehicle. Typically the station-communication module is then adapted for sending said operative data to the certain power replenishment station at which the vehicle is located.

According to some embodiments, the system of the invention is associated with a control system of a power replenishment station (e.g. of one or more power replenishment stations/systems). The system includes an identification module adapted for obtaining at least the user data associated with a user requesting power replenishment service from the power replenishment station. The one or more communication modules of the system include a control center communication module connectable to the identification module and adapted for communicating with the control center for sending thereto at least the user-data indicative of the user requesting power replenishment services and receiving therefrom corresponding operative data of the power replenishment service to be provided to the vehicle of the user. In some cases the system further includes a replenishment controller connectable to the control center communication module and adapted for utilizing the operative data for operating the power replenishment system associated with the power replenishment station.

According to some embodiments, in which the system is associated with a control system of a power replenishment station, the identification module may be adapted for carrying out at least one of the following:
communicate with a user device for receiving therefrom the user-data indicative of a user requesting power replenishment services.
communicate with the control system of the vehicle for receiving therefrom the vehicle-data.
communicate with the control system of the vehicle for receiving therefrom user-data indicative of a user requesting power replenishment services.
obtain, from at least one of the user device and the control system of the vehicle, corresponding vehicle associated data which is to be communicated to the control center.

According to some embodiments of the invention one or more of the power replenishment stations include one or more battery charging poles. Alternatively or additionally one or more of the power replenishment stations include one or more battery exchange systems/stations.

According to some embodiments of the invention at least one power replenishment station includes an identification module including at least one of an RFID, NFC, BT and WIFI communication devices adapted for communicating with a user device in the vicinity of the service station for receiving the user-data therefrom. In some embodiments one or more of the communication modules of the system are configured and operable for communication with a user device for receiving therefrom at least one of the following: the vehicle data, vehicle associated user data indicative of a user using the vehicle, and one or more factors associated with at least one of the vehicle and the user.

According to some embodiments of the invention, the system (e.g. one of the communication module(s) thereof) is adapted for wireless communication with a control system of the vehicle for at least partially receiving therefrom at least one of the following: the vehicle data, vehicle associated user data indicative of a user using the vehicle, and one or more factors associated with at least one of said vehicle and said user.

According to some embodiments of the invention, after determining the vehicle located in the vicinity of a certain power replenishment station, the system (e.g., the processor utility) is configured and operable for identifying battery information of the vehicle and communicating operational data for servicing the battery to the certain power replenishment station. The operational data may for example include at least one of the following: battery information indicative of the vehicle's battery and/or battery replenishment plan for servicing the battery. In the later case the battery replenishment plan is determined in accordance with the battery information and may include operational data for charging a battery of the vehicle and/or operational data for replacing the battery of the vehicle. In this connection it should be noted that according to some embodiments of the invention the system (e.g. the processing utility) may be also adapted to determine whether the user is authorized to receive power replenishment service for the respective vehicle.

According to another broad aspect of the present invention there is provided a method for use in servicing of electric vehicles. The method includes: receiving and processing user request data from at least one power replenishment service station for identifying therein user data indicative of a user requesting power replenishment service(s); receiving and processing data from control systems of vehicles for identifying certain data including at least specific vehicle data; and processing the user data and the at least specific vehicle data and identifying the respective vehicle located at the power replenishment service station. Then data indicative of the respective vehicle is generated to thereby enable management of services to be provided to the respective vehicle.

According to some embodiments of the method of the present invention the certain data obtained from control systems of a vehicle includes associated user data indicative of a user using the vehicle. Alternatively or additionally the method includes: identifying a list of a plurality of vehicles associated with the user based on identification of the user requesting power replenishment service(s); obtaining one or more factors associated with at least one of a vehicle to be serviced and the user; and utilizing the one or more factors to determine which respective vehicle of the plurality of vehicles in the list is located adjacent to the power replenishment station. Specifically the one or more factors may be utilized to filter the lists and thereby determine a match between one of the vehicles in the list and the user. The one or more factors may for example include one or more of the following: a charge event received from the vehicle adjacent to the power replenishment service station, a vehicle usage history associated with the user, battery service history associated with the user, and location of the vehicle.

In this connection the method step of identifying the respective vehicle which is located adjacent to the power replenishment station (e.g. which is associated with the user) may include at least one of the following:
matching vehicle associated user data indicative of a user using the vehicle with the user data,
providing a list of a plurality of vehicles associated with the user and filtering the list by utilizing one or more factors associated with at least one of the vehicle and the user.

According to some embodiments the method of the present invention includes at least one of the following procedures are performed for receiving at least one of the user data, the vehicle-data and/or one or more factors associated with at least one of the vehicle and the user:
communicating with a user device for receiving therefrom said user-data.
communicating with the control system of the vehicle for receiving therefrom the vehicle-data.
communicating with the control system of the vehicle for receiving the user-data.
obtaining, from at least one of a user device and a control system of the vehicle, corresponding vehicle associated data including at least one of the following: the vehicle data, a vehicle associated user data indicative of a user using the vehicle, and the one or more factors.

According to some embodiments the method further includes utilizing the vehicle data and determining corresponding operative data for power replenishment of the vehicle. In this connection the method may include identifying battery information of the respective vehicle and communicating operational data for servicing the battery to the certain power replenishment station. The operational data may for example be determined in accordance with the battery information. The operational data may include a battery replenishment plan for performing at least one of the following: charging a battery of the vehicle, and replacing the battery of the vehicle. In some case the method also includes determining/verifying whether the user is authorized to receive power replenishment service for the respective vehicle. Only after determining that the user is entitled to such services, the operational data is provided to the power replenishment service station.

It should be understood that although such utilities as NFC card and GPS might be used for the purposes of the invention, the invention does not need any processing of combined GPS and NFC data, but rather utilizes a match between the user identity embodied in the NFC card, the EV identity stored in the in-vehicle system and the charge pole at the service station. This matching may be achieved by indirect communication between these elements with mediation of a mobile handset.

It should also be understood that the system according to the invention may be a suitably programmed computer. Likewise, the invention contemplates a computer program being readable by a computer for executing one or more of the methods of the invention which are described above and further described in detail below. The invention further contemplates a machine-readable memory tangibly embodying a program of instructions executable by the machine for executing one or more methods of the invention. Accordingly the service system of the present invention may be implemented utilizing computer system capable of communicating with at least one power replenishment service station and with control systems installed in/carried by electric vehicles. The service system may be located at the control center connectable to multiple remote power replenishment service stations via a network, or may be located at the specific power replenishment service station, or the utilities of the service system may be distributed between the power replenishment service stations and control center.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates an electric vehicle network.

FIG. 2 is a high-level block diagram illustrating an exemplary distributed computer system in accordance with some embodiments.

FIG. 3 is a block diagram illustrating a command center system in accordance with some embodiments.

FIG. 4 is a flow diagram illustrating a method of identifying a vehicle adjacent to a battery service system in accordance with some embodiments.

FIG. 5 is a block diagram illustrating information used in identifying a vehicle adjacent to a battery service system in accordance with some embodiments.

FIG. 6 is a schematic illustration of a power replenishment network according to the invention including a control center and service stations.

FIG. 7A is a flow diagram illustrating an embodiment of a method, to be carried out by a control center of a power replenishment network, for identification of a vehicle to be serviced by a service station.

FIG. 7B is a flow diagram illustrating an embodiment of a method, to be carried out by an EV control system, to allow EV identification at a service station.

FIG. 7C is a flow diagram illustrating an embodiment of a method, to be carried out by the service station to allow identification of the EV and obtain operative data to service the vehicle.

For clarity, elements having common or similar functions or purposes may be indicated with the same reference numerals in the figures.

### DETAILED DESCRIPTION OF EMBODIMENTS

Methods and systems for identifying electric vehicles adjacent to battery service systems are described. Reference will be made to certain embodiments of the invention, examples of which are illustrated in the accompanying drawings.

In the following description, numerous specific details are set forth to provide a thorough understanding of the present invention. However, it will be apparent to one of ordinary skill in the art that the invention may be practiced without these particular details. In other instances, methods, procedures, components, and networks that are well-known to those of ordinary skill in the art are not described in detail to avoid obscuring aspects of the present invention.

The terminology used in the description of the embodiments herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

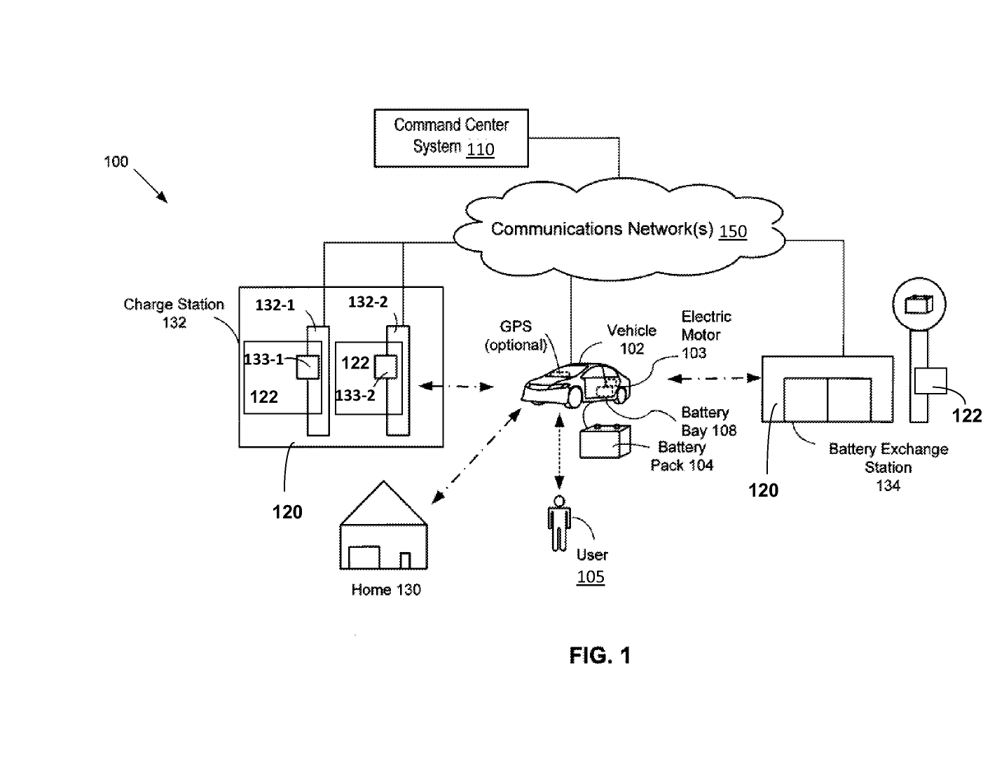

FIG. 1 illustrates an electric vehicle service system/network 100, according to some embodiments of the present invention. The electric vehicle service system 100 is associated with one or more vehicles (e.g. vehicle 102) which are in turn associated with one or more battery packs (e.g. battery pack 104) configured to be mounted to the vehicles. In some embodiments, the battery pack 104 is removably mounted to the vehicle 102. Also, in some embodiments, the battery pack 104 includes any device capable of storing electric energy such as batteries (e.g., lithium ion batteries, lead-acid batteries, nickel-metal hydride batteries, etc.), capacitors, reaction cells (e.g., Zn-air cell), etc. In some embodiments, the battery pack 104 comprises a plurality of individual batteries or battery cells/chemical modules. In some embodiments, the battery pack 104 also comprises cooling mechanisms, as well as mechanical and electrical connectors for connecting to the vehicle 102 or the battery pack 104 to various elements of power replenishment service stations 120.

The electric vehicle service system/network 100 may be implemented as a computerized system capable of communicating via a communication network(s) with one or more power replenishment service stations (e.g., with control-systems/controllers thereof) and with control-systems (e.g. onboard computers) installed in/carried by electric vehicles.

As noted above, due to communication deficiencies in the existing standards for EV charging, accurate and reliable techniques for identification of an EV adjacent to a charging pole are lacking. For reasons described above, existing techniques for vehicle identification may fail to provide accurate and reliable results when used at charging poles, particularly when the poles are located at close proximity to one another. The present invention solves this problem by providing an accurate and reliable EV identification technique which may be used by any type of service stations including battery charging stations (e.g. charging poles). To this end, the service system 100 is configured for identification of EVs in the vicinity of service stations, enabling servicing of the respective vehicles.

The electric vehicle service system 100 may be associated with (e.g. located at) a central station (termed here interchangeably as command center system or control center) 110 connectable to multiple remote power replenishment service stations via a communication network, or it may be associated with (e.g. located at) the specific power replenishment service station 120, or the utilities of the service system 100 may be distributed between the power replenishment service stations 120 and the control center 110. It is noted that the terms power replenishment service station and battery service station are used here interchangeably for referring to any power replenishment facilities for electric vehicles including, but not limited to, battery exchange stations/systems 134 and battery charge stations/poles 132. A battery service station includes one or more power replenishment systems. As used herein the term “power replenishment system” refers to a charging pole and/or battery exchange system of the power replenishment service stations. In some embodiments, these components of the service system 100 are connected to related power and data networks, as explained in more detail in U.S. patent application Ser. No. 12/234,591, filed Sep. 19, 2008, entitled Electronic Vehicle Network, the disclosure of which is incorporated herein by reference.

In some embodiments, the vehicle 102 (also called herein an electric vehicle) includes an electric motor 103 that drives one or more wheels of the vehicle. In some embodiments, the electric vehicle 102 may be a hybrid vehicle e.g. also including a gas-powered engine, which may be used to drive one or more wheels of the vehicle independently or in conjunction with the electric motor 103. In these embodiments, the electric motor 103 receives energy from the battery pack 104 (shown separate from the vehicle for ease of explanation).

The battery pack 104 of the vehicle 102 may be charged at a home 130 of a user 105 or at one or more battery charge stations/poles 132. For example, a charge station 132 may be located in a shopping center parking lot. The charge stations 132 provide energy to charge the battery pack 104 while it is coupled to the vehicle 102. A respective charge station 132 may include one or more charging poles (e.g., 132-1 and 132-2). A charging pole includes an electrical system configured for charging the battery of a respective electric vehicle.

Furthermore, in some embodiments, the battery pack 104 of the vehicle 102 can be exchanged for a charged battery pack at one or more battery exchange stations 134. Thus, the spent (or partially spent) battery can be exchanged for a charged battery so that the user can continue with his/her travels without waiting for the battery to be recharged. The battery exchange stations 134 are service stations where a user can exchange spent (or partially spent) battery packs 104 of the vehicle 102 for charged battery packs 104. A respective battery exchange station 134 includes one or more battery exchange systems. A respective battery exchange system includes a mechanical system configured for exchanging batteries for a respective electric vehicle.

In some embodiments, the power replenishment service station 120 (e.g. battery exchange stations 134, charge station 132, and/or charging poles 132-1 and 132-2) may include a user identification module 122 which is capable of obtaining/receiving user identification data (also referred to herein as UID). The user identification module 122 may be configured and operable for receiving user-data UID via communication with a user (handheld) device 121 such as an RFID/NFC card/unit or a mobile device, cellular phone and the like. For example here the charging poles 132-1 and 132-2 each includes a near-field communication reader (e.g., 133-1 or 133-2) that is configured to receive user identification from a near-field communication device (e.g., a transmitter) carried by the user 105. The user data UID may be embedded in an NFC module or other communication module/card of the user's device (e.g. user data may be hard coded data). Alternatively or additionally, user authentication/validation protocol may be executed over communication established between the user identification module 122 and the user device 121. Such protocols may be used for example in order to prevent fraud and/or ambiguous user identifications. The user-data UID is generally indicative of a user seeking battery replenishment services (e.g. battery exchange and/or charging) from the service station 120, or in other words, user-data UID presents or is a part of a user request data for power (battery) replenishment services. Such user request data may further include identifying information or a network address of the respective battery service station/system.

The vehicle 102 is described herein as located adjacent to a power replenishment system when the vehicle 102 is positioned for receiving a battery service from a power replenishment system. For example, the vehicle 102 may be located proximate from a charging pole (typically within reach of a charging cable) when the vehicle is located adjacent to the charging pole. Alternatively, the vehicle 102 may be located on a battery exchange system when the vehicle 102 is located adjacent to the battery exchange system.

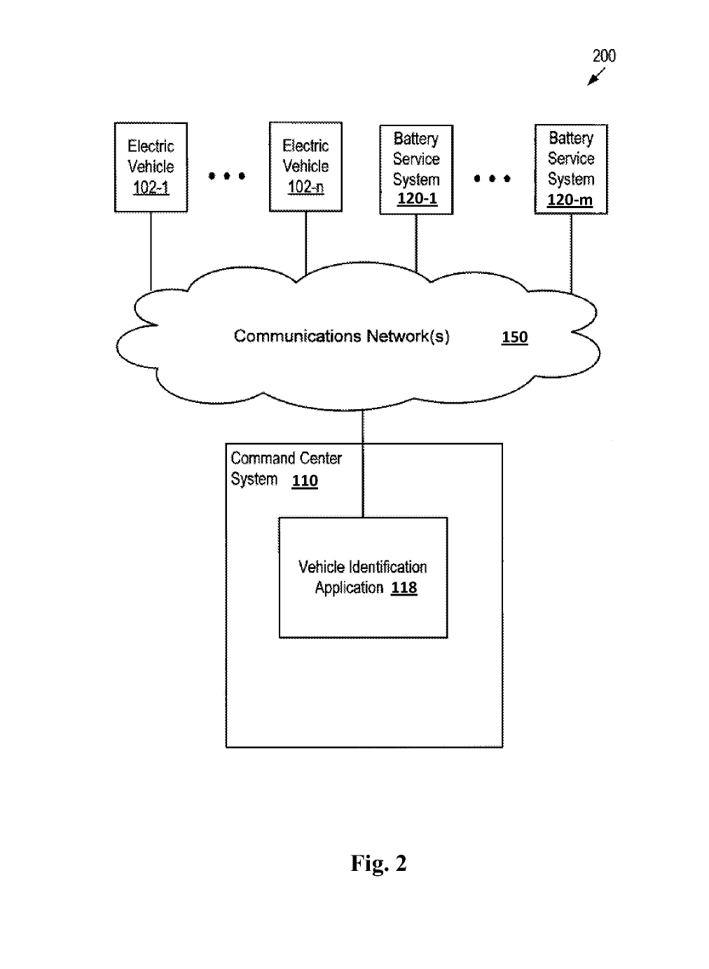

In some embodiments, the power replenishment stations/systems are connected to a command center system 110 via communications network 150. An exemplary distributed computer system corresponding to the electric vehicle service system 100 is described with respect to FIG. 2.

FIG. 2 is a high-level block diagram illustrating an exemplary distributed computer system 200 in accordance with some embodiments. System 200 includes one or more electric vehicles 102, one or more power replenishment systems/stations 120 (e.g., the battery charge station 132 and/or the battery exchange station 134 in FIG. 1), a communications network 150, and a command center system 110. The one or more electric vehicles 102 and the one or more power replenishment systems 120 are connected to the command center system 110 via the communications network 150. Typically, a plurality of electric vehicles 102 and a plurality of power replenishment systems 120 are associated with the system 200. In some embodiments, multiple power replenishment systems 120 are located in proximity to one another (e.g., multiple charging poles at a charge station 132). Various embodiments of the command center system 110 implement the methods described in this document.

The command center system 110 may include one or more servers/communication modules connected to communications network 150. Optionally, the one or more servers are connected to the communications network 150 via a front end server (not shown). In some embodiments, the front end server conveys (and optionally parses) inbound requests to the appropriate server of the command center system 110, and formats responses and/or other information being sent to other servers or power replenishment systems 120 in response to requests. In some embodiments, the front end server conveys information between the vehicle and the command center system 110. Such information may include inbound information such as vehicle related data which may be indicative for example of the vehicle's identification, the current user of the vehicle and/or the vehicle's position.

The command center system 110 typically includes one or more applications and one or more databases for managing operations of the power replenishment systems 120. For example, power replenishment systems 120 may be configured for use by registered users who currently subscribe to respective battery service plans (for charging or exchanging the batteries). When a respective user of a respective electric vehicle 102 requests a service at a respective power replenishment system 120, the command center system 110 may be asked to confirm whether the requesting user currently is authorized for the service. For example, the command center system 110 may be asked to confirm whether the requesting user subscribes to a battery service plan. Furthermore, in some cases, the battery service plan may have certain restrictions on the battery service (e.g., a total number of battery exchanges per month, total energy to be used in charging the battery, remaining account balance, etc.). In such cases, the command center system 110 may be asked to confirm whether the requesting user can receive the requested service in accordance with his or her battery service plan. Based on the determination, the requesting user may be allowed or denied the requested service, or may be prompted to upgrade his or her battery service plan.

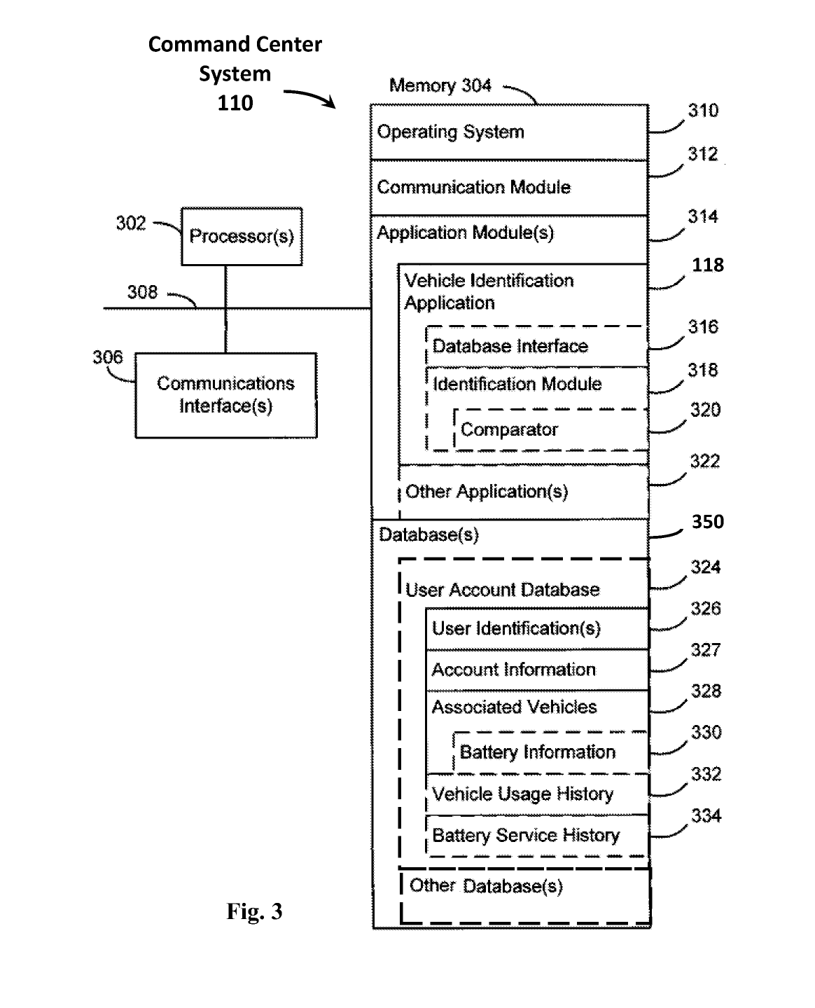

The command center system 110 typically includes a vehicle identification application 118 (e.g. vehicle locator module) for identifying an electric vehicle associated with the requesting user, which is described in detail with respect to FIG. 3.

FIG. 3 is a block diagram illustrating the command center system 110, in accordance with some embodiments. The command center system 110 typically includes one or more processing units (also called CPUs, microprocessors, or processors) 302, memory 304, one or more network or other communications interfaces/modules 306, and one or more communication buses 308 for interconnecting these components. In some embodiments, the communication buses 308 include circuitry (sometimes called a chipset) that interconnects and controls communications between system components. In some other embodiments, the command center system 110 includes a user interface (not shown) (e.g., a user interface having a display device, a keyboard, and a mouse or other pointing device), but more typically the command center system 110 is controlled from and accessed by various client systems (e.g., a desktop, a laptop, a portable computer, etc.).

Memory 304 of the command center system 110 may include high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 304 may optionally include one or more storage devices remotely located from the CPU(s) 302. Memory 304, or alternately the non-volatile memory device(s) within memory 304, comprises a non-transitory computer readable storage medium for storing information. In some embodiments, memory 304 or the computer readable storage medium of memory 304 stores the following programs, modules and data structures, or a subset thereof:
Operating System 310 that includes procedures for handling various basic system services and for performing hardware dependent tasks;
Network Communication Module (or instructions) 312 that is used for connecting the command center system 110 to other computers (e.g., computers in electric vehicles 102 and/or computers in power replenishment systems 120) via one or more communications interfaces 306 and one or more communications networks 150 (FIG. 2), such as the Internet, other wide area networks, local area networks, metropolitan area networks, wireless communication networks (including cellular networks), and so on;
Application modules 314 typically include a plurality of programs/modules used for managing the command center system 110. Such modules may include for example vehicle identification application 118 (e.g. vehicle locator module) as well as other application(s) 322 (e.g. battery information application/module); and
Database module(s) 350 which may include: User Account Database 324 including information about user accounts and associated information; and/or user-location database associating some of the users with specific locations they are known to be at (e.g. users located the service stations and/or users currently utilizing one or more vehicles); and/or battery information data storage associating batteries with EV's and/or storing battery information for the batteries.

The vehicle identification application (vehicle location module) 118 is configured for identifying a respective electrical vehicle located adjacent to a respective power replenishment system. The vehicle identification application 118 (e.g. vehicle locator module) may include the following interfaces, modules, programs, and data structures, or a subset or superset thereof:
Database Interface 316 that assists searching, retrieving, storing, and/or updating data stored in one or more databases 350 (e.g., the user account database 324); and
Identification Module 318 that identifies the respective electrical vehicle located adjacent to the respective power replenishment system in accordance with various inputs (e.g., user identification information).

In some embodiments, the identification module 318 includes a comparator 320 that is configured to compare information received from a respective electric vehicle 102 and data retrieved from at least one of the user account database 324 and the user-location database.

Other applications 322 of the command center system 110 include applications used for managing the command center system 110, e.g., applications (or instructions) for creating a respective account (e.g. user account), presenting information for the respective account, updating the balance of the respective account (e.g., posting charges and/or credits), archiving account information, etc.

The user account database 324 includes user account information, for example a list of user identifications 326 corresponding to registered users of the electric vehicle service system 100 (FIG. 1). For example, the registered users of the electric vehicle service system 100 subscribe to respective battery service plans. The user account database 324 may include account information 327, which includes information about respective users' battery service plans (e.g., account type, remaining balances, remaining numbers of charges or exchanges, expiration dates, etc.). The user account database 324 typically includes a list of vehicles 328 associated with each user. It is common for a single user to be associated with multiple vehicles (e.g., a member of a family that has two or more vehicles, an employee who has access to a company vehicle and a personal vehicle, a user who has access to his/her own vehicle and also to his/her friend's vehicle, a driver who frequently rents cars, etc.).

In some embodiments, the user account database 324 also includes battery information 330 that identifies a respective battery currently associated with each vehicle in the list of associated vehicles 328. The battery information 330 may include various information regarding respective batteries (e.g., type, age, charge history, temperature history, etc.). If the vehicle includes a removable battery, the identity of the battery will change over time. Alternatively or additionally in some embodiments of the present invention, battery information as well as data associating batteries with respective vehicles at which they are presently installed, may be stored in a separate data base (e.g. or battery information data storage). Utilizing such a separate battery information data base may be advantageous specifically in cases where a service provider owns and/or manages the allocation of batteries to vehicles of different users.

In some embodiments, the user account database 324 includes vehicle usage history 332 that identifies vehicles used by a respective user during a predefined time period. In some embodiments, the user account database 324 includes battery service history 334 that identifies charges or battery exchanges the respective user has requested during a predefined time period. The battery service history 334 typically identifies time, vehicle identification (e.g., a vehicle identification number), and information regarding one or more batteries (e.g., charge history, recommended voltage and current for charging the batteries, a size of the battery, etc.) for which service has been requested by the respective user.

The command center system 110 communicates with one or more databases internal to the command center system 110, such as the user account database 324 using a local area network, by internal communication busses, or by any other appropriate mechanism or combination of mechanisms.

It should be noted that in some embodiments, fewer and/or additional modules, functions or databases are included in the command center system 110. The modules shown in the command center system 110 represent functions performed in certain embodiments.

Each of the above identified modules and applications correspond to a set of one or more instructions for performing one or more functions described above. These modules need not be implemented as separate software programs, procedures or modules, and thus various subsets of these modules may be combined or otherwise re-arranged in various embodiments. In some embodiments, memory 304 may store a subset of the modules and data structures identified above. Furthermore, memory 304 may store additional modules and data structures not described above.

Notwithstanding the discrete blocks in FIGS. 2 and 3, these figures are intended to be a functional description of some embodiments rather than a structural description of functional elements in the embodiments. One of ordinary skill in the art will recognize that an actual implementation might have the functional elements grouped or split among various components. In practice, and as recognized by those of ordinary skill in the art, items shown separately could be combined and some items could be separated. For example, in some embodiments, the user account database 324 may be split into two separate databases (e.g., a user identification database that includes user identifications and associated vehicles and a history database that includes the vehicles usage history and/or the battery service history).

The number of processors and/or servers used to implement the command center system 110 and how features are allocated among them will vary from one implementation to another, and may depend in part on the amount of data stored by the command center system 110, and may also depend on the amount of data traffic that the system must handle during peak usage periods as well as during average usage periods. Moreover, one or more of the blocks (e.g., command center system 110, vehicle identification application 118, etc.) in FIG. 2 may be implemented on one or more servers designed to provide the described functionality. Although the description herein refers to certain features implemented in the command center system 110 and certain features implemented in the power replenishment system 120, the embodiments are not limited to such distinctions. For example, features described herein as being part of the command center system 110 can be implemented in whole or in part in the power replenishment system 120, and vice versa.

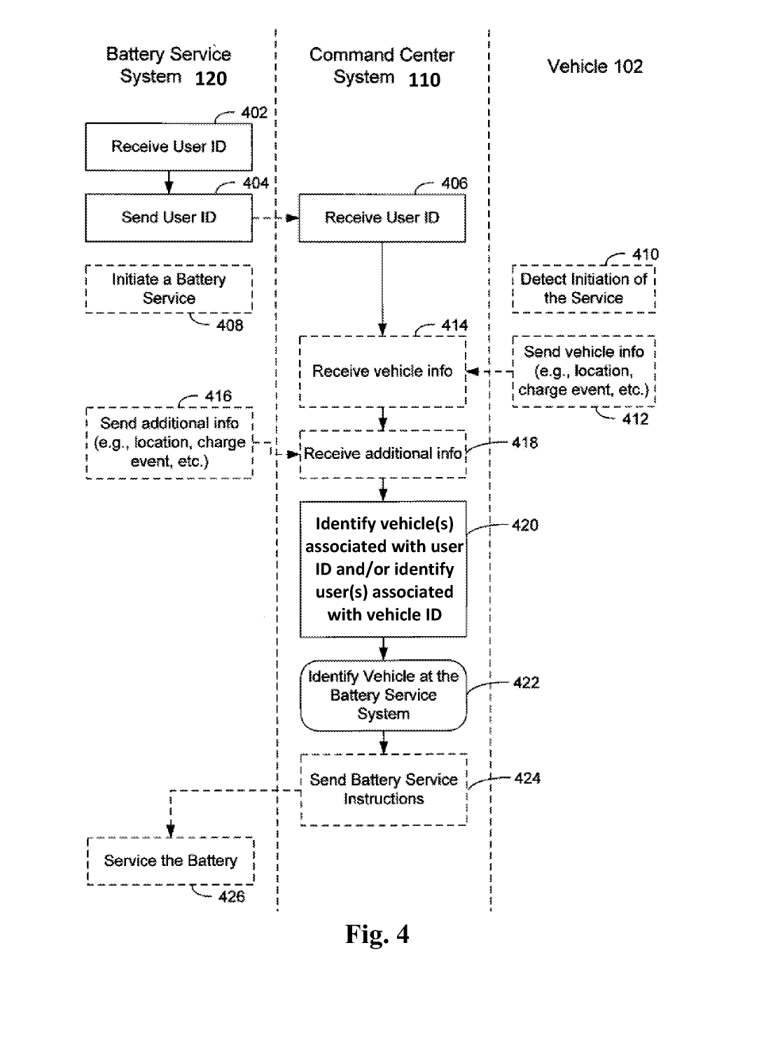

FIG. 4 is a flow diagram illustrating a method of identifying a vehicle adjacent to a power replenishment system in accordance with some embodiments. In particular, FIG. 4 illustrates respective operations performed by a power replenishment system/station 120, the command center system 110, and a vehicle 102. The command center system 110 is typically located remotely from the electric vehicle 102. The command center system 110 may be remotely located from the power replenishment system 120 or it may in some cases reside at one or more of the service stations (e.g. residing at one of them or distributed between some of them). For example, the command center system 110 may be located at a control center that is remote and distinct from the battery service station that has the power replenishment system 120.

According to some embodiments of the present invention the command center system 110 is capable of obtaining information indicative of the identity users seeking battery replenishment services in association with the respective power replenishment systems 120 from which such services are respectively sought by the users. To this end, command center system 110 may obtain data associating users with service-stations indicating the current or expected locations at which power replenishments are required for the users' vehicles. In some embodiments further described below, the user-service-station data may be stored in a user-location database. In this connection, in various embodiments of the present invention such user-service-station data is obtained/received at the command center from the service stations (e.g. from the power replenishment systems 120) or alternatively or additionally such data may be received directly from the users (e.g. from a communication devices of the users).

For example according to some embodiments, the power replenishment system 120 receives (402) user identification (the “user ID”) of a user. The user ID may comprise a user name (e.g., a full name, code name, nickname, or a pseudo-name) or code (e.g., numbers, alphabets, binary codes, or a combination thereof, etc.) that uniquely identifies the user. In some embodiments, the power replenishment system receives the user identification information from a RFID tag, which may be included in, or attached to, a key fob or a card (e.g., a credit card or an identification card) of the user. Alternatively, any other device or item that includes any other near field communication (NFC) tag or transmitter may be used. In some embodiments, the power replenishment system 120 receives the user identification from a mobile phone device associated with the user, such as via Bluetooth. In some embodiments, the mobile phone device may send the user identification to the power replenishment system via a short message service (SMS), email, dedicated application etc. Then, having received the user identification, the power replenishment system 120 sends (404) the user identification to the command center system 110. The user identification may be sent from the power replenishment system 120 to the command center system 110 via the communication network(s) 150 (FIG. 2). The command center system 110 receives (406) the user identification of the user from the power replenishment system 120 e.g. together with certain data indicating/identifying the service-station/power-replenishment-system from which the user identification is sent (e.g. such data may be the network address of the power-replenishment-system or other identifier thereof). Accordingly, the command center system 110 obtains user-service-station data associating the particular user with a particular service-station/power-replenishment-system.

Alternatively or additionally, in some embodiments, the user may utilize a communication device (such as a mobile phone) to type in identification information of the power-replenishment-system from which he seeks power replenishment services for his vehicle (e.g., the user may enter the charge pole identification number in his mobile phone) and send the power-replenishment-system identification information, together with user identification information, to the command center system 110. Accordingly, the command center system 110 obtains the user-service-station data directly from the user (e.g. from a communication device associated therewith). Thus the command center system 110 is capable of associating the particular user with a particular service-station/power-replenishment-system. It should be understood that the user identification may in this case be a data piece stored in the communication-device/mobile-phone of the user or it may be associated with other data pieces associated with the user's communication device (e.g. the phone number may serve as a user identification data). In some embodiments, the mobile phone device may send the user identification information and/or the power-replenishment-system identification information, directly to the command center system 110 without sending the user identification to the power replenishment system 120. The data may be sent from the user's communication-device via a short message service (SMS), email, dedicated application, etc.

In some embodiments, the power replenishment system 120 initiates (408) a battery service. For example, the power replenishment system 120 may include a charging pole, and the vehicle 102 may be electrically coupled with the charging pole (e.g., a charge plug from the charging pole is plugged into the vehicle 102). The charging pole may send an electric input to the vehicle 102 for determining that the vehicle 102 is electrically coupled with the charging pole. In some embodiments, the vehicle 102 detects (410) the electric input from the charging pole as an initiation of the battery service. In some embodiments, the electric input from the charging pole may initially comprise a small test charge (e.g., in order to indicate initiation of the battery service to the vehicle 102). In some embodiments, the test charge may be used to determine the type of a battery in the vehicle adjacent to the power replenishment system. Therefore, initiating the battery service may include sending the small test charge, but in some embodiments, initiating the battery service does not in fact charge the battery in the vehicle until the operation 426 is performed as described below.

In some embodiments, the vehicle 102 sends (412) vehicle information to the command center system 110. The vehicle information may include data identifying the vehicle. The vehicle information may include a charge event, which indicates that the vehicle is electrically coupled with the power replenishment system 120. However, the vehicle information typically does not identify the power replenishment system 120 with which the vehicle 102 is coupled. In some embodiments, the charge event indicates that a battery service (e.g., charging) has initiated for the vehicle 102.

In some embodiments, the vehicle information sent at 412 includes additional data including a location of the vehicle 102. When a global positioning system (GPS) receiver is included in the vehicle 102, the GPS receiver may be used to determine the location of the vehicle 102 (typically expressed as GPS coordinates). Although the GPS coordinates can be used to narrow down a list of potential power replenishment systems, it might be difficult to identify a power replenishment system located adjacent to (e.g., closest to) the vehicle 102 based on the GPS coordinates alone, especially when there are multiple power replenishment systems located in the proximity (e.g., a charge station with multiple closely-located charging poles). The command center system 110 receives (414) the vehicle information from the vehicle 102 (over the communication networks(s) 150, typically over one or more wireless communication networks).

In some embodiments, the vehicle information sent at 412 includes data identifying the vehicle 102 as well as additional data identifying the user 105 of the vehicle (e.g. the current user of the vehicle and/or a list of one or more users associated with the vehicle). In this regard it is noted that the vehicle 102 may be equipped with a control system (e.g. an onboard computer) adapted for storing information regarding the vehicle's user(s). For example the onboard computer may store information indicative of identities of multiple users which may be associated with using the vehicle 102, or the onboard computer may be adapted for communicating with the present user of the vehicle (e.g. with a communication device thereof such as a mobile phone or NFC card) for receiving therefrom data identifying the user. The vehicle information, including the data identifying the user 105, is then sent at 412 from the vehicle's onboard computer. The command center system 110 receives (414) the vehicle information from the vehicle 102 and is thus accordingly capable of associating the vehicle 102 with one or more users (typically with one user 105 being the current user who utilizes the vehicle and seeks power replenishment services).

In some embodiments, the power replenishment system 120 sends (416) additional information, such as a location of the power replenishment system 120 and/or a power replenishment system identifier that uniquely identifies the power replenishment system 120. In some embodiments, the additional information includes the charge event. Therefore, in some embodiments, the charge event received from the power replenishment system 120 and the charge event received from the vehicle 102 may be used to determine that the vehicle 102 is located adjacent to the power replenishment system 120. The command center system 110 receives (418) the additional information from the power replenishment system 120.

The command center system 110 identifies (420) the one or more vehicles associated with the user (and/or the user ID of the user). For example, the command center system 110 may retrieve the list of one or more vehicles associated with the user (e.g. associated with the particular user which identity is received at 406 from the service station). The list of one or more vehicles may be retrieved for example from the user account database 324 (FIG. 3). The command center system 110 may retrieve additional information from the user account database 324 (e.g., the vehicle usage history 332, current battery installed in each identified vehicle, and/or battery service history 334).

Alternatively or additionally, the command center system 110 identifies (420) a list of one or more users which are respectively associated with the vehicle 102. For example, this may be based on the additional information which is sent from the vehicle 102 and which may include the list of one or more users of the vehicle or the identity of the current user of the vehicle. Alternatively or additionally, this may be based on information sent from a communication device of the user 105 which, as noted above, may include identification data indicative of the vehicle 102 currently used by the user 105. Thus, a match between a particular vehicle 102 and a particular power replenishment system 120, to which the vehicle is adjacent, is accomplished according to the present invention by utilizing the user identification data received in 406 in association with a user seeking service from the particular power replenishment system 120, the vehicle info/data which is received in 414 for identifying the vehicle, and the additional information/data received in 416. As noted above, the additional data may be received from the communication device of the user and/or from the vehicle (e.g. from its on-board computer). The additional data may include data indicative of any one or more of the following: location of the particular vehicle (e.g. its GPS location), the identity of the user currently using the vehicle, a list of users associated with the vehicle, a charge event received from the vehicle and/or from the power replenishment system. The command center system 110 may also utilize one or more data storage systems (e.g. databases) associated therewith for storing said additional data and/or for retrieving therefrom yet further additional data relating users with their respective vehicles associated therewith (for example for retrieving a list of vehicles associated with a particular user and/or for retrieving a list of users associated with a particular vehicle. The further additional data may be used to improve the matching (e.g. the accuracy of the matching and/or the speed of the matching process) relating users seeking power replenishment services from particular power replenishment service stations/systems with their respective vehicles which are to be serviced.

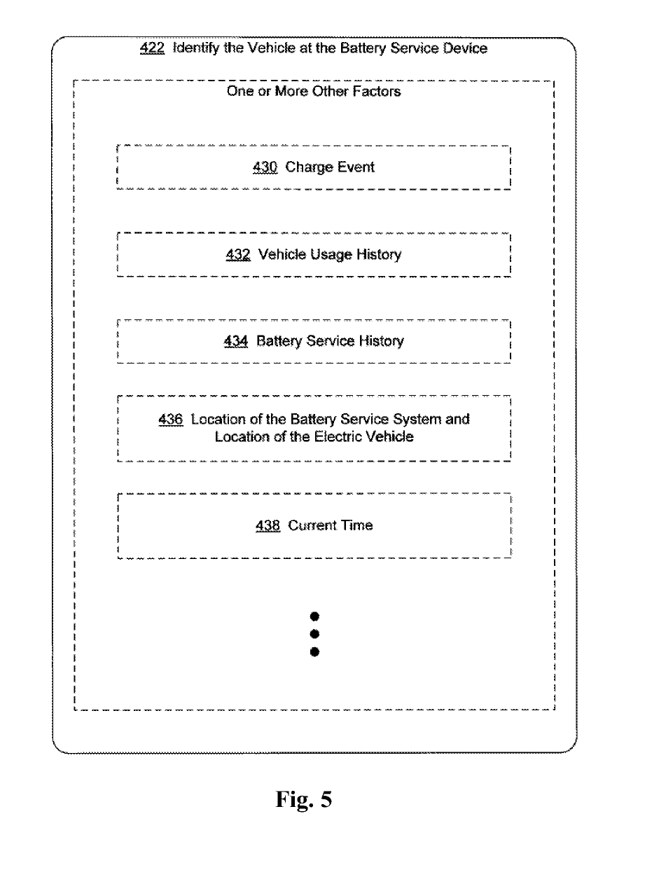

For example, FIG. 5 illustrates the identifying/matching operation carried out by the command center system 110 in some embodiments of the present invention, for determining which respective vehicle of the plurality (if more than one) of vehicles associated with the user is located adjacent to the power replenishment system. In other words, the command center system 110 identifies/matches (422) the vehicle adjacent to the power replenishment system.

Once the vehicle located adjacent to the power replenishment system 120 (and/or a battery currently carried by the vehicle located adjacent to the power replenishment system 120) is identified, the command center system 110 may send (424) one or more battery service instructions corresponding to the respective vehicle determined to be located adjacent to the power replenishment system 120. In some embodiments, prior to sending the one or more battery service instructions (e.g., the battery information 330, FIG. 3), the command center system 110 identifies battery information for the respective vehicle that is determined to be located adjacent to the power replenishment system 120.

In some embodiments, the power replenishment system 120 is a charging pole, and the one or more battery service instructions represent instructions for charging a battery of the respective vehicle in accordance with the identified battery information (e.g., recommended charging voltage and/or current, battery capacity, etc.).

In some embodiments, the power replenishment system 120 is a battery exchange system, and the one or more battery service instructions represent instructions for exchanging a battery of the respective vehicle in accordance with the identified battery information (e.g., battery size and capacity, etc.).

FIG. 5 is a block diagram illustrating information used in identifying the vehicle located adjacent to the power replenishment system in accordance with some embodiments. In particular, the command center system 110 determines which respective vehicle of the plurality of vehicles associated with the user is located adjacent to the power replenishment system based on the list of one or more vehicles associated with the user and one or more other factors (additional information/data).

In some embodiments, the one or more other factors include the charge event 430 received from the vehicle 102 (e.g., in the operation 412, FIG. 4) and/or the power replenishment system 120 (e.g., a charge pole). The command center system 110 determines, among a plurality of vehicles associated with the user, a vehicle that recently sent the charge event as the vehicle adjacent to the power replenishment system 120. In some embodiments, the charge event sent by the power replenishment system 120 is used to match the charge event sent by the vehicle 102. In some embodiments, the charge event needs to be received within a predefined time window (e.g., three minutes) from receiving the user ID in order to avoid erroneous identification of the vehicle (e.g., if the user first connects to one charge pole and then to another charge pole, or if the user connects to one charge pole and his/her spouse connects to another adjacent charge pole).

In some embodiments, the one or more other factors include vehicle usage history 432. For example, the command center system 110 identifies, among the plurality of vehicles associated with the user, a vehicle that is most frequently used by the user, and determines that the vehicle most frequently used by the user is the vehicle 102 located adjacent to the power replenishment system 120. In some embodiments, the command center system 110 determines that the vehicle most frequently used by the user around the location of the power replenishment system 120 is the vehicle 102 located adjacent to the power replenishment system 120.

In some embodiments, the command center system 110 determines among the plurality of vehicles associated with the user, a vehicle that is most frequently used by the user at times corresponding to a current time period. The command center system 110 typically identifies the current time period 438 (e.g., current time and/or a day of the week). For example, the command center system 110 identifies the current time period (7 pm on Monday); accesses the vehicle usage history to generate a list of one or more vehicles used at times corresponding to the current time period (7 pm on Mondays) during a predefined time period (e.g., past two months); and determines that a vehicle most frequently used at times corresponding to the current time period is the vehicle located adjacent to the power replenishment system 120. This assumes that the user drives the same vehicle at a same time each week.

In some embodiments, the one or more other factors include battery service history 434. In one example, the command center system 110 accesses the battery service history to generate a list of one or more vehicles that are serviced most frequently by the power replenishment system 120 (e.g., based on the location and/or the power replenishment system identifier) during a predefined time period (e.g., past two months), and determines that the vehicle most frequently serviced by the power replenishment system 120 is the vehicle located adjacent to the power replenishment system 120. Alternatively, the command center system 110 may determine that the vehicle most frequently serviced by a predefined group of power replenishment systems 120 (e.g., power replenishment systems located at the battery service station at which the specific power replenishment system 120 is located and/or from which the user request for service had been received) is the vehicle located adjacent to the power replenishment system 120. This assumes that the user services the same vehicle with the same power replenishment system or at the same battery service station.

In some embodiments, the one or more other factors include (436) a location of the power replenishment system 120 and a location of the vehicle 102. As explained previously, it is typically difficult to identify the vehicle located adjacent to the power replenishment system 120 that is located proximate to a plurality of other power replenishment systems solely based on the location of the vehicle 102 and the location of the power replenishment system 120. Therefore, the location of the power replenishment system 120 and the location of the vehicle 102 are typically used in conjunction with at least one of the other factors (e.g., the charge event 430, the vehicle usage history 432, the battery service history 434, and the location of the power replenishment system and the location of the electric vehicle 436). However, in some embodiments, the one or more other factors may include the location of the power replenishment system 120 and the location of the vehicle 102 without any other factor. In some embodiments, the command center system 110 uses a last reported location of the vehicle.

In some embodiments, the command center system 110 determines which respective electric vehicle of the plurality of electric vehicles associated with the user is located adjacent to the power replenishment system 120 based on a plurality (e.g., three or more) of the factors. In general, combining additional factors improves the accuracy of the system. In some embodiments, the command center system 110 determines which respective electric vehicle of the plurality of electric vehicles associated with the user is located adjacent to the power replenishment system 120 based on a probability function of a plurality (e.g., three or more) of the factors (e.g., the charge event 430, the vehicle usage history 432, the battery service history 434, and the location of the power replenishment system and the location of the electric vehicle 436). In some embodiments, the probability function has multiple probability terms, each corresponding to a respective factor. Each probability term in the probability function is weighed by a respective weight.

In some embodiments, the command center system 110 receives user feedback from the power replenishment system 120, which indicates that the command center system 110 has accurately determined the vehicle located adjacent to the power replenishment system 120. In accordance with the user feedback, the command center system 110 may adjust the respective weights of the probability function.

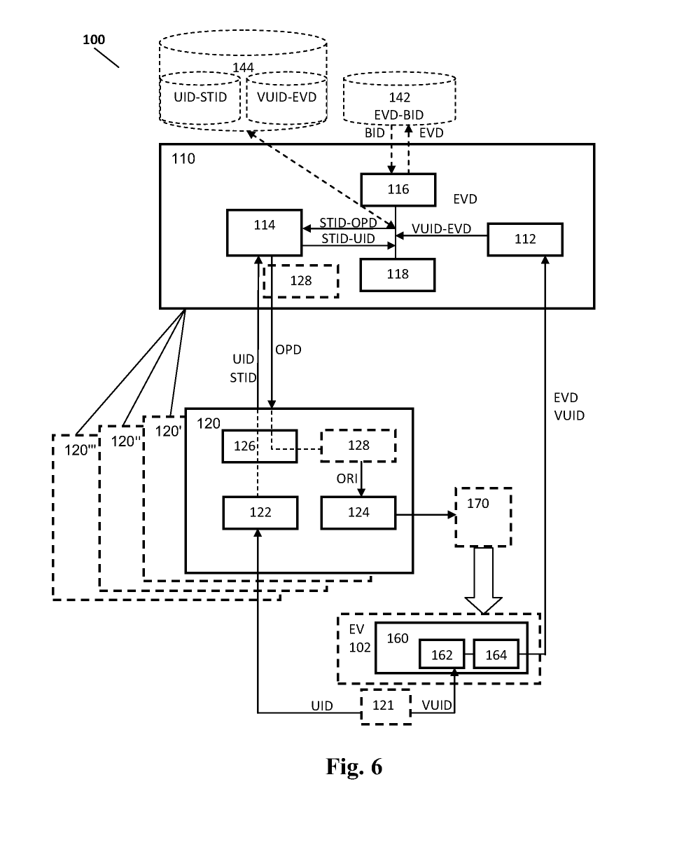

FIG. 6 is a schematic illustration of an electric vehicle service system/network 100 according to another embodiment of the invention. The service system 100 may be implemented as computer system capable of communicating, via a communication network, with power replenishment service stations (four such service stations 120, 120′, 120″, 120′″ are shown in the figure) and with control systems 160 installed in/carried by electric vehicles (not specifically shown). The service system 100 is configured for identification of EVs in the vicinity of service stations, enabling servicing of the respective vehicles.

Here, the electric vehicle service system 100 is responsive to user data (e.g. user request data) received from the power replenishment service station 120 (e.g. charging pole or battery exchange station), and is also responsive to vehicle data received from the control system 160 the EV 120, and is further responsive to additional data. The additional data may include one or more factors associated with at least one of the users requesting service of at the service station 120 and the vehicle of the user. For example, as noted above, the one or more factors may include vehicle related user data indicative of the identity of the current user of the vehicle (i.e. vehicle related user data) and/or vehicle position data which may indicate the current location of the vehicle or the route of the vehicle. The one or more factors, such as vehicle related user data or vehicle position data, may for example be received from the vehicle's control system 160 or from another source.

The electric vehicle service system 100 operates to process these data pieces (e.g. the user request data, the vehicle data and the additional data) to identify the respective EV located at the service station 120 and to thereby enable/facilitate management of service provision to said vehicle. In this connection the system 100 includes a command center system (i.e. control center) 110 connectable to multiple power replenishment service stations 120 (e.g. via a communication network). The command center system may also reside at one of the service stations 120, or be distributed between them.

In the specific not limiting example of FIG. 6, the service system 100 presents a so-called electric vehicle service network including at least one service station 120 (e.g. service station control system) and a control center 110 which is capable of communicating with the at least one service station 120. As noted above, the control center 110 as well as control systems of the service stations 120 may be implemented by utilizing computer systems including inter alia one or more processors and memory storing one or more programs/applications for execution by the one or more processors. The one or more programs may include instructions for carrying out methods according to the invention for identifying an EV in the vicinity of the service station. In some embodiments of the present invention, the service stations, or at least some of them, also include one or more processors for executing programmatic instructions as will be exemplified further below.

Service station control system 120 includes a replenishment controller (control system) 124 that is associated with a battery replenishment machinery/circuitry 170 and is configured and operable for operating the battery replenishment machinery/circuitry 170 in accordance with a desired replenishment scheme. A battery replenishment machinery/circuitry 170 may include, for example, a charging pole for charging an EV battery and/or it may include a battery exchange system capable of replacing an EV battery.

In the embodiment of FIG. 6 the electric vehicle service system 100 is configured and operable for determining a desired replenishment scheme of a user's EV, the service station 120 (e.g. the control system 124 thereof) includes a user identification module 122 and a control center communication module 126 connectable thereto. Communication module 126 is adapted for communicating with the control center associated with the service station. The user identification module 122 is adapted for obtaining user's identification data, which is transmitted to the control center through the communication module 126.

The communication module 126 communicates the user-data UID (e.g. being data indicative of user request for power replenishment service(s) from the service station 120) to the control center 110. The data user-data UID may be communicated to the control center 110 together with identifying information or a network address of the service station 120. The communication module 126 receives from the control center 110 in response, operational data OPD indicative of power replenishment service to be provided by the service station. More specifically, the operational data OPD may be indicative of the type of battery replenishment to be provided to an electric vehicle associated with the user. Operational data OPD may, for example, include operative replenishment instructions/plan ORI or it may include indicative data from which such instructions can be obtained/determined.

Replenishment controller 124 is adapted to receive the operative replenishment instructions ORI from the communication module 126 and generate operative data to operate a battery replenishment machinery/circuitry 170 associated with the service station 120 to replenish the EV battery in accordance with a replenishment scheme indicated by the operative replenishment instructions ORI.

As indicative above, the operational data OPD may include operative replenishment instructions ORI. Alternatively or additionally, operational data OPD may include battery information data BID and possibly also data EUD indicative of the user's profile and/or EV usage from which such operative replenishment instructions ORI can be determined.

In various embodiments of the invention, the operative replenishment instructions ORI are determined by a replenishment processing module 128 that is associated with either one of the control center 110 or the service station 120, or with both of them. Generally, the replenishment processing module 128 utilizes battery information data BID to determine one or more preferred battery replenishment schemes. To this end, replenishment processing module 128 may also utilize data indicative of the type of the service station 120 (e.g. being a charging pole or a battery exchange station) and/or data indicative of possible replenishment schemes which are available at the service station 120, and based on such data determine the preferred replenishment scheme. Also replenishment processing module 128 may utilize EV usage data indicative of a history of the EV usage or its predicted usage to select the most suitable replenishment scheme from those available by the service station 120.

The service station 120, associated with either one of a charging pole and a battery exchange system or with both of them, may be operated to provide various battery replenishment services such as various charging schemes (e.g. fast/slow, full/partial charging) and/or exchange batteries of various types and charging levels. Accordingly, the operative replenishment instructions ORI may include data indicative of the type and method of battery replenishment service to be supplied to the electric vehicle EV of the user, as well as specific preferred replenishment schemes (battery charging scheme and/or battery exchange preferences and/or exchange-priority).

Turning now to the control center 110, it communicates operative data OPD to the service station 120 in response to user-data UID received therefrom. As indicated above, the operative data OPD typically includes battery-specific and/or vehicle-specific data. Having received the user-data UID from the service station 120, the control center 110 is adapted for determining battery information for the EV to be serviced by service station 120. The control center 110 identifies the vehicle to be serviced and obtains battery information corresponding to the battery installed thereon (i.e. the battery type and possibly also the specific battery identity).

There is generally no one-to-one correspondence between EV's and users. Also, the service station 120 may not communicate the identity of the vehicle adjacent thereto to the control center 110. This is because some existing EV replenishment standards lack communication between a service station 120 and a vehicle adjacent thereto, and thus a service station 120 is typically unaware of such a vehicle's identity.

To this end, the control center 110 includes communication modules (e.g. manifested by one or more communication/frontend servers) including an EV communication module 112 and a station-communication module 114, and includes data-processing modules including a battery information module 116 and a vehicle locator module 118, which are connectable to the communication modules for exchanging information between them. The EV communication module 112 is adapted for communication with one or more EV's for receiving therefrom vehicle associated user data VUID and EV related data EVD. The station-communication module 114 is configured and operable for communication with one or more service stations (e.g. 120) associated with the control center 110. The station-communication module 114 is adapted for receiving, from the service stations (e.g. 120), one or more user-data pieces UIDs indicative of users seeking/requesting battery replenishment services. The user data pieces UID's are obtained in association with station-data STID identifying or indicative of the respective service stations from which they were sent.

Having received user-data piece UID from a certain service station, the vehicle locator module 118 operates for identifying/matching that user data piece UID with a vehicle associated user data VUID that is obtained from an EV by the EV communication module 112. The vehicle locator module 118 thereby associates the EV related data EVD with that certain service station, thus allowing for communicating proper operative data OPD thereto. In other words, the vehicle locator module 118 determines which EV is located in the vicinity of the certain service station.

In some embodiments of the invention, the user data UID and the vehicle associated user data VUID may include different user related data content. In such embodiments the vehicle locator module 118 may operate a match user data UID with vehicle associated user data VUID by utilizing user data records which associate these different user related data contents.

Battery information module 116 is configured and operable for utilizing the EV related data EVD to determine battery information BID corresponding to the type/identity of the battery installed on the corresponding EV. Then, in accordance with the determined battery information BID, an operative data OPD is sent by the station-communication module 114 to the service station, at which the corresponding EV is located.

According to some embodiments of the invention, the control center 110 is associated with user-location data storage 144 (e.g. database). The user-location data base 144 may be configured and operable for storing association data, associating vehicle associated users (VUID's) with the EV's (EVD's) they are using (e.g. currently using). Such a VUID-EVD association data may for example be provided to the database by EV communication module 112 (e.g. when such data is sent from an EV in response to the user-identification in the EV as described above). Utilizing such VUID-EVD data storage, the vehicle location module 118 can operate in response to user-data UID received from the service station 120 (e.g. which may be identified by STID) to associate the user data UID with an EV used (i.e. determine a corresponding EV data EVD) and thereby determine association STID-EVD between the EV and the service station.

Alternatively or additionally, the user-location database 144 may be configured and operable for storing association data, associating users (UID) with service stations (STID) they have recently being identified at (e.g. via their user devices). Such a UID-STID association data may for example be provided to the database 144 by station-communication module 112. Utilizing such UID-STID data storage, the vehicle location module 118 can operate in response to vehicle related user-data VUID received from an EV to associate the EV data EVD with the service stations STID (i.e. determine STID-EVD association).

As described above, the vehicle location module 118 provides STID-EVD association between a specific service station (e.g. station-data) and an EV to be serviced thereby. The battery information module 116 utilizes the EV related data EVD to determine the EV battery information BID and possibly also to determine EV usage data. Optionally, according to some embodiments, the battery information module 116 includes or is associated with a battery information data storage 142, associating batteries with EV's and storing battery information for the batteries. Battery information module 116 utilizes such battery data storage to acquire battery information BID for the EV, thus allowing for determining the type/identity of the batteries that can be serviced at different service stations (e.g. STID-BID association).

As noted above, operative data OPD to be sent to a service station may include data indicative of the battery information BID and/or operative replenishment instructions ORI. In the latter case, the control center may also include a replenishment processing module similar to processing module 128 described above. The replenishment processing module 128 may utilize the battery information BID and possibly also other data to determine operative replenishment instructions ORI to be sent to the respective service station.

It should be noted that the service station communication module 114 may utilize any suitable wired or wireless communication technology for communicating with the service stations. This may include for example LAN, Wireless LAN (WAN/WIFI), Ethernet, Internet, telephony, cellular (e.g. 3G) networks. In some types of networks, the network address (MAC/IP) itself may be used as or incorporated in the station-data STID. Alternatively or additionally, station-data STID may include any data indicative of a specific service station such as a serial number of the station. In some cases, authentication protocols are used to authenticate/validate service-data STID stations and/or to secure communication with the service stations.

EV communication module 112 may also utilize wired or wireless communication technology/network to communicate with one or more EV's. It may utilize a network similar to that used by the station communication module 114 or a network of other type. EV communication module 112 may also utilize local Bluetooth or WIFI networks, which exist at the service stations, to connect to EV's in the vicinity of the service stations. Communication module 114 may utilize suitable authentication protocols to communicate data between the vehicle and the control center. Such protocols may assist in prevention of false or fraud communications of vehicle identifying data EVD and vehicle related user data VUID.

As noted above, the EV communication module 112 receives (through the network) a vehicle associated user data VUID and a vehicle related data EVD. According to some embodiments of the invention, the vehicle related data EVD, which identifies data, is inherently/implicitly communicated to the control center for example in the form of a network address (e.g. IME/MAC address) of the vehicle's communication device. The vehicle associated user-data VUID is typically obtained by the vehicle's computer or vehicle's control system 160 from a user device associated with the user of the vehicle or by direct (manual) input from the user.

The EV control system 160 is appropriately accommodated in the vehicle EV and is adapted for receiving vehicle associated user-data VUID as an input and communicating this data together with vehicle related data (e.g. vehicle/battery identification data) EVD to the control center 110. Typically, in some embodiments of the invention, the control system 160 includes one or more processors and memory storing one or more programs for execution by the one or more processors. The one or more programs may include instructions for carrying out methods of the invention, as will be exemplified further below.

The EV control system 160 includes at least a user identification module 162 and a vehicle controller 164. The user identification module 162 is adapted to obtain vehicle associated user-data VUID. The vehicle controller 164 is connectable to the user identification module 162 and is adapted to obtain therefrom the vehicle associated user-data VUID and to communicate it together with a vehicle related data (EVD) to the control center 110 to notify the control center of the user driving the vehicle.

To this end, the user identification modules, 162 and 122, of the vehicle 160 and the service station 120 may utilize similar data input technology or different technologies. More specifically, vehicle associated user-data VUID and user-data UID may be directly provided by users to the respective modules 162 and 122, e.g. by manual data entry by the user through a user input device such as a key-pad, or automatically via a user device 121 associated with one or both of the modules 162 and 122. A non-limiting list of suitable techniques for automatic identification of user devices to any one of modules 162 and 122 include: Bluetooth communication, Wireless-LAN (WIFI), Radio Frequency Identification (RFID) and Near-Field communication (NFC). By using some of these techniques, the data indicative of the user may also be securely communicated using suitable authentication/validation techniques/protocols. Also such data may be inherently communicated to the respective vehicle/service station (e.g. to the respective module 162/122) for example in the form of a network address of the user device 121. Such data indicative of the user may also be implicitly communicated whenever a connection between the user device 121 and the respective module 162/122 is established.

It should be understood that, generally, different user devices 121 may be used to communicate with the user identification modules 162 and 122. For example, a credit card may be used to identify the user before the identification module 122 of the service station, while a mobile phone equipped with an NFC/Bluetooth can be used to connect to the user identification module 162 of the EV. In this connection, it should be noted that the user-data UID communicated to the control center via the service station may be different from the vehicle associated user data VUID which is communicated from the EV to the control center 110. Following the above example, the user data UID may be a credit card number, and the vehicle associated user data VUID may be the MAC address of the user's mobile and/or other authentication data transmitted from a user's device. In such cases, the control center also utilizes a UID-VUID association data (not shown, e.g. lookup table or database) to be able to match between the UID and VUID data (i.e. to allow identification of a UID within a list of VUID's or vice-versa).

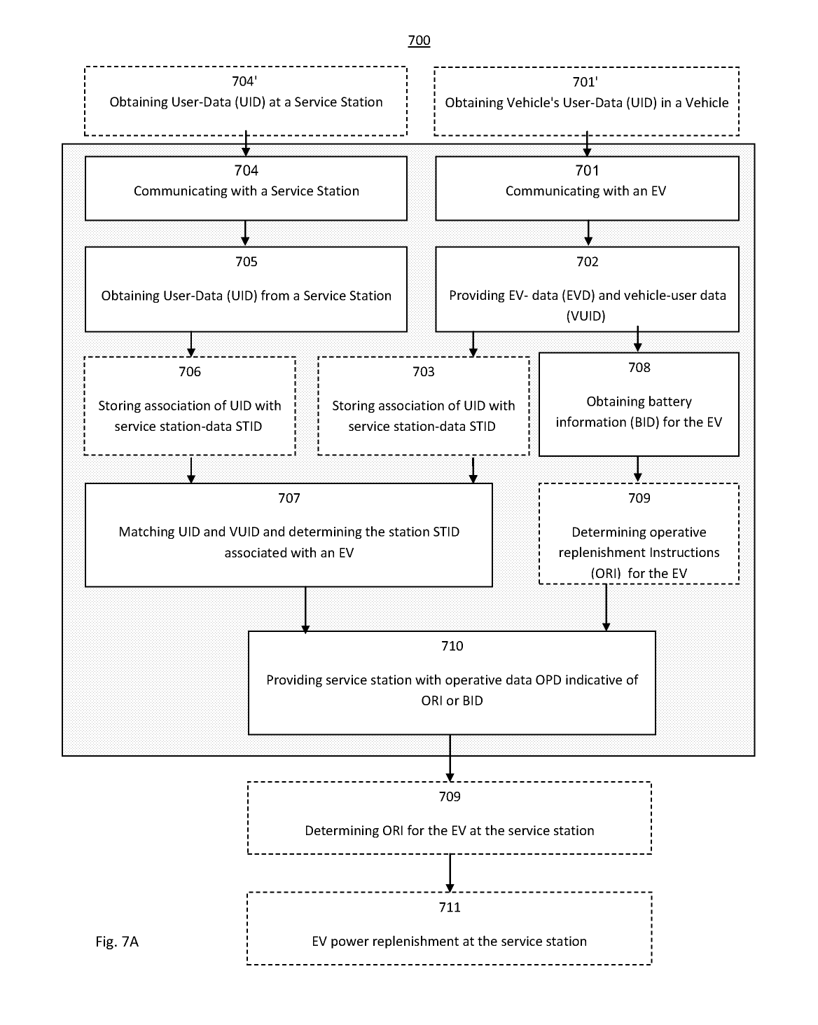

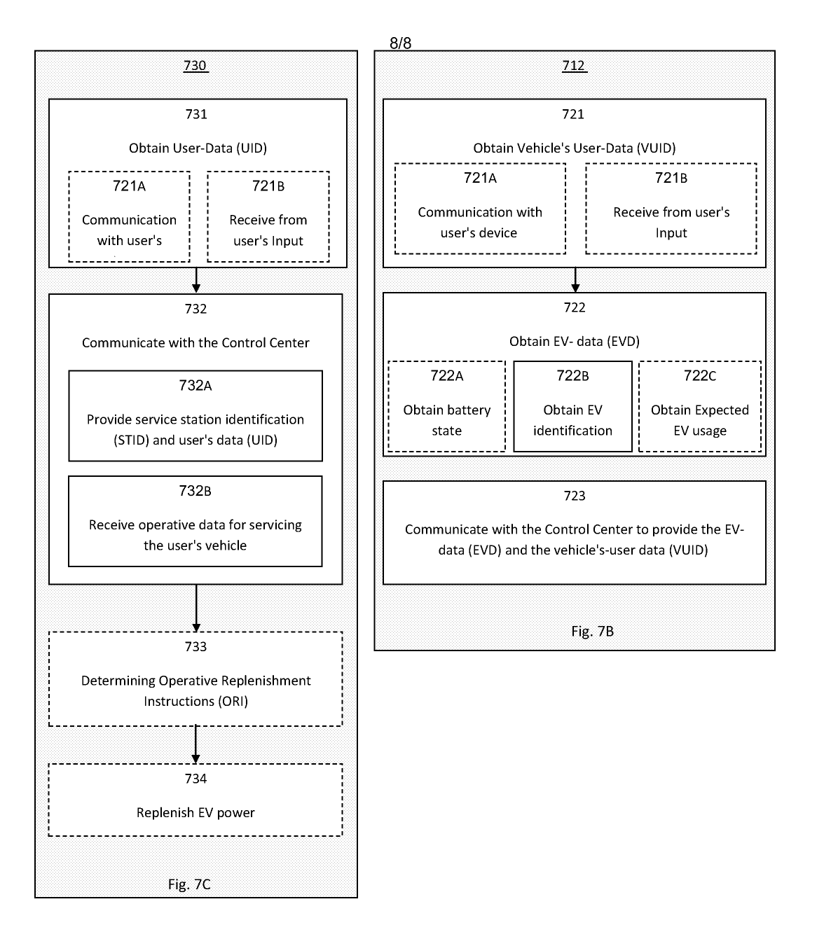

Some specific but not limiting embodiments of methods, according to the invention, for identifying an electric vehicle adjacent to a service station will now be described with reference to FIGS. 7A to 7C. It should be understood that these methods may be performed utilizing a computerized system or a distributed system/network having one or more processors and one or more memory modules storing one or more programs for execution by the processor(s).

In accordance with some embodiments, the methods are carried out by software modules embodied in a non-transitory computer readable storage medium that stores one or more programs for execution by one or more processors of a computerized system. For example, such one or more programs may include instructions for carrying out any one of the methods described below.

Reference is made to FIG. 7A which is a flow diagram 700 illustrating a method for identification of an electric vehicle located in the vicinity of a service station. This method can be implemented for example by electric vehicle service network 100 described above. More specifically, steps 701 to 710 (communicating with EV, and providing operative data indicative of ORI or BID to service station) are implemented by the control center 110 of electric vehicle service network 100 to identify an EV in the vicinity of a service station. Steps 701′ and 704′ (obtaining vehicle related user data (UID) in the vehicle's computer and obtaining user data (UID) at a service station), enable the EV's user to be identified by control systems 160 and 120 of the EV and the service station, respectively. These procedures occur prior to the operational steps 701 and 704 at the control center. According to some embodiments of the invention, in the preliminary steps 701′ and 704′, the user is identified utilizing technologies, such as NFC, which may be embedded in a user's handheld device. For example, user-data UID may be wirelessly communicated to the control system 120 of the service station by such a handheld device.

To this end, it should be noted that the EV identification should be construed herein as either identifying the EV's identity or identifying the EV's battery identity or identifying the EV's battery type, all in accordance with the desired embodiment of the invention and with the contents of the electric vehicle related data that is provided by the vehicle.

Step sequence 701 to 703 (communication with an EV, provision of EV data and vehicle-user data and recordation of association data with respect to the user data and service station data) is performed by the control center in response to data coming from the EV and/or from the service station. Step sequence 704 to 706 (communication with a service station, obtaining user data from the service station, and recording association data with respect to the user data and service station data) is performed in connection with each user approaching the service station (i.e. identifying himself at the service station). These procedures 701 to 703 and 704 to 706 can be performed concurrently or in any suitable order.

Thus, in step 701, communication is established between the control center and the EV. This communication can be initiated by the EV's control system (e.g. 160 in FIG. 1), for example in response to user/user-device identification by the EV's control system indicating user's usage of the vehicle. Alternatively or additionally, according to some embodiments of the invention, communication can be initiated by the control center for interrogating the EV approaching/located at a certain service station to generate a request to the respective user to provide his identifying information (user's identity or user data). In case the communication is initiated by the control system, a corresponding notification message may be transmitted via a user's phone device, which may not be part of that user device which communicates with the vehicle's control system. The manner in which the EV's control system communicates with the service system (control center and/or power replenishment service station) is defined according to a previously established agreement between the user/vehicle and the service system.

In step 702, following communication establishment with the EV, the control center receives an EV related data (EVD) and vehicle associated user data (VUID) which is provided by the EV's control system. Optionally, in step 703 the vehicle associated user data VUID is stored in a VUID-EVD data storage in association with the EV (with the EV data). Such data records can thereafter be used to determine relations between users and vehicles.

In step 704, communication is established between the control center and the power replenishment service station (e.g. 120 in FIG. 1). Such communication may be initiated by the service station in response to user data received at the service station (i.e. identification of a user seeking to receive services therefrom); or the communication may be initiated by the control center where a request for user data is generated to the service station in response to the vehicle data EVD and vehicle associated user data VUID received from the vehicle's control system.

The user-data UID is communicated to the control center at step 705, and association between the user data UID and data (STID) indicative of the service station is obtained. Optionally this association is stored, in step 706, in a UID-STID data storage (database) indicating users at different service stations.

In step 707, the data processor of the service system (in this example, the data processor of the control center) operates to analyze the received data to find a match between vehicle associated user data VUID, obtained from the EV's control system, and user data UID obtained from the service station to determine an association data UID-VUID. This association data is indicative of association between the vehicle requesting services and the service station where such a vehicle is currently located. By utilizing the association data VUID-EVD between vehicles and users obtained in step 702 and the association data UID-STID between users and service stations obtained in step 705, an association data EVD-STID between the electric vehicle and the service station is obtained. This association data EVD-STID indicates the location of a certain EV in the vicinity of a certain service station.

In steps 708 and 709, which follow the previously described step 702, operative replenishment instructions ORI are generated by the service system (e.g. control center) with respect to the specific EV identified in step 702. In step 708, the electric vehicle related data EVD is used to determine the battery type/identity of the vehicle, and to obtain battery information relating thereto. It should be noted that in some embodiments of the invention, the electric vehicle related data EVD may by itself include or be constituted by data indicative of the battery type/identity or, generally, indicative of battery information (BID). In such embodiments, step 708 might be obviated. In some other embodiments, the battery information BID may be obtained from a database (data storage) associating contents of the electric vehicle related data EVD with the battery information BID.

Step 709 can be performed by either the control center or by the power replenishment service station. In this step, the battery information BID is processed and used to determine operative replenishment instructions ORI with respect to the vehicle. As noted above, such instructions may include preferred/suitable battery replenishment (charging/exchange) schemes. As was also noted above, such instructions may be based on the vehicle data, such as vehicle usage, which may be obtained in step 708.

In step 710, the service system (e.g. control center) operates to generate operative data OPD, containing the battery information BID (obtained at 708) and/or the operative replenishment instructions ORI (obtained at 709) for the vehicle, and communicate this operative data OPD to the service station at which the vehicle is located (as determined at 707). Optionally, as noted above, step 709 may then be carried out to determine operative replenishment instructions ORI at the service station. The operative replenishment instructions ORI can then be used by the respective facilities of the service station (charging pole or exchange station) to provide power replenishment services to the vehicle (step 711).

It should be understood, and is indicated above, that the service system may be associated with a control system of a power replenishment station having a plurality of battery service facilities (charging poles and/or battery exchange stations). Thus, the “control center” described above may be constituted by a control system of the power replenishment station which is capable of communicating with EV's control systems and control systems of the battery service facilities. Thus, for example, a user identifies himself (i.e. provides user data to) before the control center of the power replenishment station via the data entry to the control unit of a specific charging pole, and the control system of the user's vehicle transmits vehicle related data and vehicle associated user data to the control center of the power replenishment station. The latter processes and analyses these data and generates operative data OPD and operative replenishment instructions ORI to the corresponding charging pole.

Reference is made now to FIG. 7B which is a flow diagram 712 illustrating an example of a method carried out by a vehicle's control system (e.g. 160 in FIG. 1) to allow its identification when in the vicinity of a service station. First, in step 721, the vehicle's control system is operated to obtain/identify the user of the vehicle. As noted above, this may be achieved by utilizing communication between the vehicle's control system and a user device (e.g. Bluetooth enabled device and/or NFC, RFID devices)—step 721A, or may be achieved via a user input to the vehicle's control system (step 721B). Step 721 may be performed, at any time before replenishment of vehicle's power by the service station is required. For example it may be operated to seek the user's identity/use-data before a user commences use of the vehicle or just before the vehicle receives power replenishment service.

In step 722, the vehicle's related data (EV-data) EVD is provided. This may be performed concurrently, before and/or after step 721. The provision of vehicle's related data EVD includes obtaining vehicle identification data (step 722A) which is indicative of the type or identity of the battery of the vehicle. The identification data may include a vehicle-unique-identifier such as license-number or chassis-number, or a battery identification data such as a battery unique serial number and/or battery type. The vehicle identification data may be hard or soft coded in a memory accessible by the control system 160 of the vehicle. In case the identification data is battery related data, it may be stored in the memory utility of the battery unit/pack itself and accessed by the control system 160.

In optional step 722B, the vehicle's control system is also operated to obtain battery state information to be embedded in the vehicle's related data EVD. Such battery state information may for example include data indicative of the current battery charge level and/or the previous characteristic of power usage (so-called “battery history”). Such data can be used to determine the expected replenishment of power of the battery under different charging conditions. Moreover, in optional step 722C, data indicative of the expected vehicle/battery usage may also be obtained included in the vehicle's related data EVD. For example, such data may include data indicative of a trip distance and/or trip destination and/or a vehicle's global position. Such data may be obtained for example from a GPS service/utility that is associated with the vehicle's control system, and may or may not be part of the user device.

Finally, in step 723, the vehicle's control system communicates with the control center to provide it with the vehicle related data EVD and with the vehicle associated user data VUID. Such communication may be for example manually instantiated by the vehicle's user. Such communication may also be instantiated automatically when the vehicle is being connected to a charging pole of the service station or when the vehicle's control system identifies an access-point (e.g. WIFI/BT) of a service station (e.g. 120 in FIG. 1), and/or the communication may be initiated by a control system (command center) of the battery replenishment service station, as well as any other suitable triggering event.

FIG. 7C is a flow chart 730 illustrating an embodiment of a method carried out by the control system of a power replenishment service station (e.g. by 120 in FIG. 1). This method includes step 731 of receiving user-data from a user requesting service. Similarly to provision of user data UID in step 721 of the method described above with reference to FIG. 7B, in the present example of FIG. 7C the user data can be obtained from a user's device (step 731A) and/or user's input to the respective system, which may be the vehicle's control system or that of the service station (step 731B).

In step 732, communication is established between the service station and the control center, where in step 732A the service station identification data (STID) is provided to the control center together with the user's data (UID), and in step 732B the service station receives, from the control station, response data including operative data for servicing (replenishing the power of) the user's vehicle. In step 733, operative replenishment instructions (ORI) data is extracted from the received operative data, thereby enabling power replenishment by operating the replenishment module utilizing the ORI (step 734).

Thus, the present invention provides for facilitating the servicing of electric vehicles at power replenishment stations. The service system of the present invention may be associated with a control system of the power replenishment service station and/or control system of the central station connected to multiple power replenishment service stations. The service system operates to identify a user's vehicle at certain power replenishment service stations (or a specific service facility of the service station) and provide optimal replenishment instructions for servicing a specific vehicle.

Those skilled in the art will readily appreciate that various modifications and changes can be applied to embodiments of the invention as hereinbefore described without departing from its scope defined in and by the appended claims Particularly, persons having ordinary skill in the art would recognize that a computer system located at the power replenishment system 120 may perform one or more of the operations described as performed by the command center system 110. In other words, the operations described as performed by the command center system 110 may be performed by the computer system located at the power replenishment system 120 or at a battery service station.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A service system for use in facilitating servicing of electric vehicles, the service system comprising one or more communication modules for connection to a communication network, and a processor utility configured and operable for carrying out the following: receiving and processing user request data from at least one power replenishment service station for identifying user data, receiving and processing data from control systems of vehicles for identifying certain data comprising at least specific vehicle data, and processing said user data and said at least specific vehicle data, identifying the respective vehicle located at the power replenishment service station, and generating data indicative thereof thereby enabling management of servicing of the respective vehicle.

2. The system of claim 1 wherein said certain data comprises vehicle associated user data indicative of a user using said vehicle.

3. The system of claim 1, wherein said processing utility is configured and operable for carrying out the following: obtaining one or more factors associated with at least one of said vehicle and said user, identifying a list of a plurality of vehicles associated with the user based on the identification of the user, and utilizing said one or more factors to determine which respective vehicle of the plurality of vehicles associated with the user is located adjacent to the power replenishment station.

4. The system of claim 3 wherein at least one of said factors is included in said certain data.

5. The system of claim 3 wherein the one or more factors comprise one or more of the following: a charge event received from the vehicle located adjacent to the power replenishment service station, a vehicle usage history associated with the user, battery service history associated with the user, a location of the vehicle.

6. The system of claim 1, wherein said processing utility is configured and operable for identifying said respective vehicle by carrying out at least one of the following:
(a) matching said user data with vehicle associated user data indicative of a user using said vehicle,
(b) processing data indicative of a list of a plurality of vehicles associated with the user by filtering said data indicative of said list by utilizing one or more factors associated with at least one of said vehicle and said user, said filtering comprising at least one of the following:
i) utilizing at least one of a vehicle and battery usage history associated with the user and determining that a vehicle frequently used by the user is said respective vehicle,
ii) matching a charge event data received from a certain vehicle in said list with a charge event received from said power replenishment station,
iii) matching a location of a certain vehicle in said list with a location of said power replenishment station.

7. The system of claim 1, being configured and operable as a control center connectable to one or more power replenishment service stations via the communication network, said one or more communication modules comprising: an electric vehicle (EV) communication module configured and operable for communication with control systems of multiple EVs and receiving therefrom at least said vehicle data, a station-communication module configured and operable for communication with the one or more power replenishment stations for receiving therefrom the user request data including at least said user data.

8. The system of claim 6, comprising a vehicle locator module adapted to utilize data received from the control system of the vehicle and data received from said one or more power replenishment stations to determine a certain power replenishment station in the vicinity of which said vehicle is located.

9. The system of claim 6, wherein said EV communication module is configured to communicate with the control system of the vehicle by mediation of a power replenishment station being said certain power replenishment station in the vicinity of the vehicle.

10. The system of claim 7 comprising a battery information module adapted to utilize said vehicle data and determine corresponding operative data for power replenishment of the vehicle, said station-communication module being adapted for sending said operative data to said certain power replenishment station.

11. The system of claim 1, being associated with a control system of the power replenishment station, the system comprising an identification module adapted for obtaining at least the user data associated with a user requesting power replenishment service, said one or more communication modules comprising a control center communication module connectable to said identification module and adapted for communicating with a control center for sending thereto at least said user-data and receiving therefrom corresponding operative data of the power replenishment service, the system further comprising a replenishment controller connectable to said control center communication module and adapted for receiving said operative data for operating the power replenishment system associated with said power replenishment station.

12. The system of claim 11, wherein said identification module is adapted for carrying out at least one of the following:
(a) communicating with a user device for receiving therefrom said user-data.
(b) communicating with the control system of the vehicle for receiving therefrom the vehicle-data.
(c) communicating with the control system of the vehicle for receiving said user-data.
(d) obtaining, from at least one of said user device and control system of the vehicle, corresponding vehicle associated data which is to be communicated to the control center.

13. The system of claim 1, wherein at least one of the power replenishment stations comprises a battery charging pole.

14. The system of claim 1, wherein at least one of the power replenishment stations comprises a battery exchange station.

15. The system of claim 1, wherein at least one power replenishment station comprises an identification module including at least one of an RFID, NFC, BT and WIFI communication devices adapted for communicating with a user device in the vicinity of the service station for receiving said user-data therefrom.

16. The system of claim 1, wherein said one or more communication modules are configured and operable for communication with a user device for receiving therefrom at least one of the following: said vehicle data, vehicle associated user data indicative of a user using said vehicle, and one or more factors associated with at least one of said vehicle and said user.

17. The system of claim 1, being adapted for wireless communication with a control system of the vehicle for at least partially receiving therefrom at least one of the following: said vehicle data, vehicle associated user data indicative of a user using said vehicle, and one or more factors associated with at least one of said vehicle and said user.

18. The system of claim 1, wherein said processor utility is configured and operable for identifying battery information of the vehicle and communicating operational data for servicing the battery to said certain power replenishment station.

19. The system of claim 18, wherein said operational data comprises at least one of said battery information and battery replenishment plan.

20. The system of claim 19, wherein the battery replenishment plan is determined in accordance with the battery information and comprises operational data indicative of at least one of the following: operational data for charging a battery of the vehicle, and operational data for replacing the battery of the vehicle.

21. The system of claim 1, wherein said processing utility is adapted to determine whether the user is authorized to receive power replenishment service for said respective vehicle.

22. A method for use in servicing of electric vehicles, the method comprising:
receiving and processing user request data from at least one power replenishment service station for identifying user data, receiving and processing data from control systems of vehicles for identifying certain data comprising at least specific vehicle data, and processing said user data and said at least specific vehicle data, identifying the respective vehicle located at the power replenishment service station, and generating data indicative thereof thereby enabling management of servicing of the respective vehicle.

23. The method of claim 22 wherein said certain data comprises vehicle associated user data indicative of a user using said vehicle.

24. The method of claim 22 comprising: obtaining one or more factors associated with at least one of said vehicle and said user, identifying a list of a plurality of vehicles associated with the user based on identification of the user, and utilizing said one or more factors to determine which respective vehicle of the plurality of vehicles associated with the user is located adjacent to the power replenishment station.

25. The method of claim 24 wherein the one or more factors comprise one or more of the following: a charge event received from the vehicle adjacent to the power replenishment service station, a vehicle usage history associated with the user, battery service history associated with the user, and location of the vehicle.

26. The method of claim 22, wherein said identifying of the respective vehicle includes at least one of the following:
(a) matching vehicle associated user data indicative of a user using said vehicle with said user data,
(b) providing a list of a plurality of vehicles associated with the user and filtering said list by utilizing one or more factors associated with at least one of said vehicle and said user, said filtering comprising at least one of the following:
i) utilizing at least one of a vehicle and battery usage history associated with the user and determining that a vehicle frequently used by the user is the respective electric vehicle,
ii) matching a charge received from a certain vehicle in said list with a charge event received from said power replenishment station,
iii) matching a location of a certain vehicle in said list with a location of said power replenishment station.

27. The method of claims 22 comprising utilizing said vehicle data, and determining corresponding operative data for power replenishment of the vehicle.

28. The method of claim 22, comprising at least one of the following:
(a) communicating with a user device for receiving therefrom said user-data.
(b) communicating with the control system of the EV for receiving therefrom therefrom the vehicle-data.
(c) communicating with the control system of the EV for receiving said user-data.
(d) obtaining, from at least one of a user device and control system of the EV, corresponding vehicle associated data including at least one of the following: said vehicle data, a vehicle associated user data indicative of a user using said vehicle, and one or more factors associated with at least one of said vehicle and said user.

29. The method of claim 22 comprising identifying battery information of the respective vehicle and communicating operational data for servicing the battery to said certain power replenishment station.

30. The method of claim 29 comprising utilizing and determining said operational data in accordance with said battery information; said operational data including battery replenishment plan indicative of at least one of the following: operational data for charging a battery of the vehicle, and operational data for replacing the battery of the vehicle.

31. The method of claim 22, comprising determining whether the user is authorized to receive power replenishment service for said respective vehicle.
